(19) United States
(12) Patent Application Publication
(10) Pub. No.: US 2012/0158827 A1
(43) Pub. Date: Jun. 21, 2012

(54) ACTIVE SERVER SYSTEM MONITOR

(75) Inventor: Robin Montague Mathews, Westford, MA (US)

(73) Assignee: Verizon Patent and Licensing Inc., Basking Ridge, NJ (US)

(21) Appl. No.: 12/974,635

(22) Filed: Dec. 21, 2010

(51) Int. Cl. G06F 15/16; G06F 15/173

(52) U.S. Cl. 709/203; 709/224

(57) ABSTRACT

A system may include a home media server, a plurality of clients of the home media server, and a plurality of entities executed by the home media server and configured to provide media content instances to the plurality of clients. The system may further include an active server system monitor configured to register an entity of the plurality of entities, determine at least one monitoring parameter associated with the registered entity, monitor the registered entity according to the at least one monitoring parameter to determine an issue with the registered entity, and if an issue is determined, terminate and restart the registered entity.

### BACKGROUND

The advent of computers, electronic communication, and other advances in the digital realm of consumer electronics has resulted in a great variety of enhanced programming, recording, and viewing options for users who view media content such as television programs. In implementing such enhanced options, the set-top box (“STB”) has become an important computing device for accessing media content services and the media content within those services. In addition to supporting traditional analog broadcast video functionality, STBs also support an increasing number of digital services such as video-on-demand, internet protocol television (“IPTV”), and personal video recording.

An STB is typically connected to a media content provider, and includes hardware and software necessary to provide enhanced options for a subscriber television system at a subscriber location. An STB is usually configured to provide users with a large number and variety of media content choices. For example, a user may choose to view a variety of broadcast television programs, pay-per-view services, video-on-demand programming, Internet services, and audio programming via an STB.

### BRIEF DESCRIPTION OF THE DRAWINGS

FIG. 1 illustrates an exemplary system having a client-server implementation of the serving of media content.

FIG. 2 illustrates an exemplary home media server having an active system monitor.

FIG. 3 illustrates an exemplary scenario of monitoring entities for responsiveness by an active server monitor.

FIG. 4 illustrates an exemplary scenario of monitoring entities for resource utilization by an active server monitor.

FIG. 5 illustrates an exemplary scenario of monitoring entities for abnormal termination by an active server monitor.

FIG. 6 illustrates an exemplary process flow for monitoring of entities by an active system monitor.

### DETAILED DESCRIPTION

A typical American home includes two or three televisions, and some have many more. For households that subscribe to media content services, each television may require its own STB to connect to the media content provider. Because these STBs are typically not in communication with one another, a show recorded on one STB may not be available for viewing on another STB in the home. Moreover, STBs may be expensive to purchase or rent, and each additional STB may increase the overall cost of media content to the household.

Rather than requiring each television to be connected to its own STB, a client-server system may be implemented in which a home media server is installed in the home. The home media server may be in communication with the media content provider, and each television may then use one of several thin client devices to access the home media server. In turn, the home media server may include one or more client handlers configured to respond to requests from the client devices.

Such a client-server system may allow for smaller and simpler client devices than requiring a full STB for each television. In some examples, the client functionality may be implemented substantially as embedded hardware and/or software included within the television itself. The home media server of the client-server system may further facilitate the sharing of recorded programming among the televisions within the home.

While the client-server system may have these and other advantages over a system having multiple separate STBs, as a consequence of the client-server design, an error condition on the home media server may not be isolated to a particular client and may result in multiple client devices experiencing a failure condition.

For example, it may be possible for an entity executed by the home media server, such as a client handler or device driver, to consume enough resources of the server that other clients may be starved of the resources they require. This starvation could occur due to various reasons, such as “buggy” computer code including programming mistakes, or incorrect computer code implementing a logically faulty algorithm. Resource starvation caused by improper operation of an entity may result in some or all of the clients experiencing decreased service, or even total failure.

As another example, an error condition may potentially result in an entity executed by the home media server performing execution of an infinite loop. Such an infinite loop may cause the offending entity to consume an excessive amount of server resources, potentially locking out all other entities. This may also cause a decrease or failure in service to some or all clients of the home media server.

Accordingly, because the home media server may be a single point of failure, an active system monitor may be implemented within the home media server to register entities executed by the server to be monitored, detect problematic issues, and remedy these issues to prevent performance degradation or loss of service.

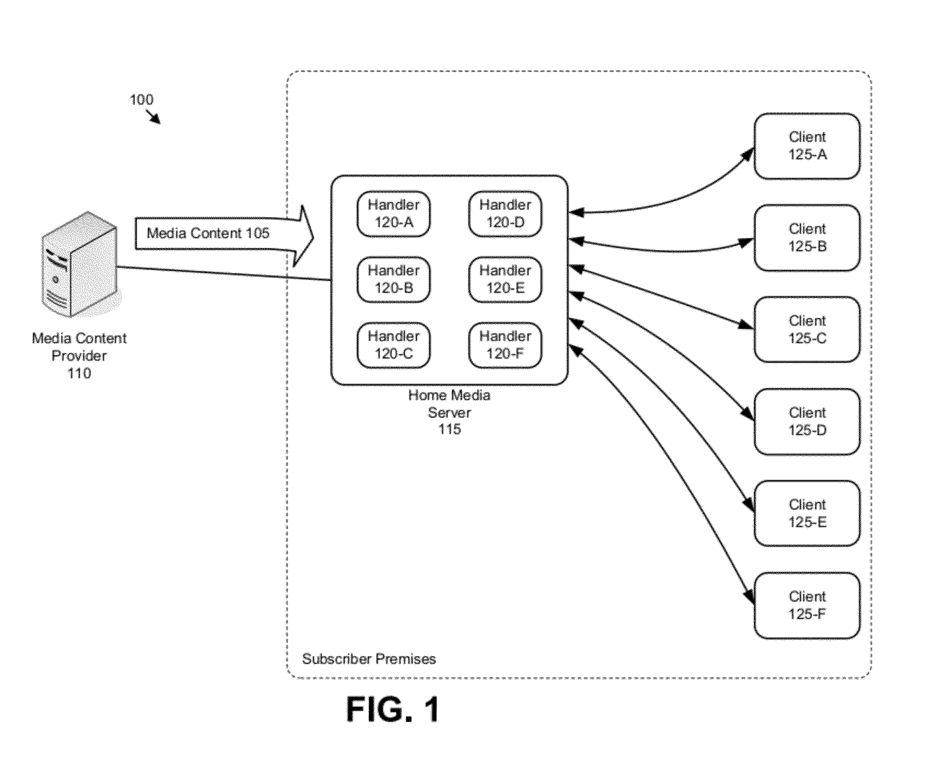

FIG. 1 illustrates an exemplary system 100 having a client-server STB implementation. The system 100 includes a media content provider 110 configured to provide media content 105 to a home media server 115. The home media server 115 may include a plurality of client handlers 120, and may communicate with a plurality of clients 125 by way of the handlers 120. System 100 may take many different forms and include multiple and/or alternate components and facilities. While an exemplary system 100 is shown in FIG. 1, the exemplary components illustrated in Figure are not intended to be limiting. Indeed, additional or alternative components and/or implementations may be used.

The term media content instance (or instance of media content 105) may be used to refer generally to any television program, on-demand program, pay-per-view program, broadcast media program, video-on demand program, commercial, advertisement, video, multimedia, movie, song, photograph, audio programming, network services (e.g., Internet), or any segment, portion, component, or combination of these or other forms of media content that may be presented to and experienced (e.g., viewed) by a user. A media content instance may have one or more components. For example, an exemplary media content instance may include a video component and an audio component. Media content 105 may include one or more media content instances.

The media content provider 110 may be configured to provide various types of media content 105 including, but not limited to, any of the forms of media content 105 described above. The media content provider 110 may further be configured to provide other data, such as data for the display of an interactive program guide. The media content provider 110 may include one or more servers configured to communicate with the home media server 115 via one or more types of networks and communications links. Exemplary networks may include the Internet, an intranet or other private packet-switched network, a cable television network (e.g., a hybrid fiber-coax network), a wireless broadcast network (e.g., a satellite media broadcasting network or terrestrial broadcasting network), a telephone network, a provider-specific network (e.g., a Verizon® FIOS® network), an optical fiber network, or any other suitable network. In some examples, media content 105 and interactive program guide data may be provided by separate servers within the media content provider 110.

The home media server 115 may be configured to communicate with and receive media content 105 containing one or more media content instances from the media content provider 110. The home media server 115 may further be configured process the media content 105 provided by the media content provider 110. For example, the home media server 115 may include one or more tuners configured to extract and process media content 105 from particular television channels, streams, addresses, and/or frequencies. As another example, the home media server may receive media content 105 over an IP channel or stream.

The media content 105 processed by a tuner of the home media server 115, or received over IP, may be temporarily buffered, or stored, in a live cache buffer. If there are multiple tuners, each tuner may be associated with a live cache buffer configured to store received media content 105. The received media content 105 stored in a live cache buffer may be served to one or more clients 125 of the home media server 115. In many examples, the home media server 115 may include multiple tuners to allow for multiple instances of media content 105 to be simultaneously processed and served. Additionally, in the absence of tuners, the direct receipt of media content 105 and services over IP is possible.

The media content 105 stored in the live cache buffer may be more permanently stored on a storage device of home media server 115 as a recording. Storage devices may include one or more data storage media or devices, such as hard drives, network drives, flash drives, magnetic discs, optical discs, or any other tangible non-transitory storage device.

Handlers 120 included in the home media server 115 may be configured to receive requests from the plurality of clients 125, process the requests, and provide the requested media content 105 or other data to the clients 125. The clients 125 may communicate with the handlers 120 of the home media server 115 through various communication technologies, devices, media, and protocols supportive of remote data communications, including, but not limited to, intranets, local area networks, wireless networks (e.g., Wi-Fi, Bluetooth), optical fiber networks, data transmission media, communications devices, Transmission Control Protocol (“TCP”), Internet Protocol (“IP”), File Transfer Protocol (“FTP”), Telnet, Hypertext Transfer Protocol (“HTTP”), socket connections, Ethernet, and other suitable communications networks and technologies. As shown, the system 100 includes six handlers 120, labeled 120-A through 120-F, and six clients 125, labeled 125-A through 125-F. While six handlers 120 and clients 125 are shown by way of example, systems including more of fewer handlers 120 and clients 125 are possible.

In a client-server STB system 100 that delivers media content 105 and/or other services, it may be beneficial to have an ability to compartmentalize service delivery to each client 125 for a better user experience. Accordingly, in some examples each client 125 may be mapped to or otherwise associated with a particular handler 120 configured to handle all requests from the associated client 125. For example, each of clients 125-A through 125-F may be mapped to one of handlers 120-A through 120-F. Such a mapping or association of clients 125 with handlers 120 may simplify compartmentalization of the usage of an individual client 125 to a certain portion of resources of the home media server 115. In other examples, client 125 requests are handed by one or a pool of handlers 120 that are idle or available to process the client 125 request.

Each client 125 may include a receiver configured to receive input commands from a user input device. These commands may be configured to enable a user to manipulate various viewing options of the media content 105 provided to the client 125 by the home media server 115. The user input device may include, for example, a remote control, keyboard, or any other suitable input device configured to communicate with the receiver via a wireless link, infrared link, electrical connection, or any other suitable communication link.

Commands received from a user input device by the client 125 may be forwarded to the appropriate handler 120 of the home media server 115 for processing. For example, a user of the client 125 may input a command requesting for a particular instance of media content 105 to be displayed, and the client 125 may forward this request to the home media server 115 to be handled by the handler 120 associated with the client 125.

A client 125 may be further configured to receive media content 105 from a handler 120 of home media server 115. This received media content 105 may be from a tuner or IP stream, or from a storage device of the home media server 115. The client 125 may further be configured to present the instance media content 105 received from the handler 120 of the home media server 115. Presentation of an instance of media content 105 may include, but is not limited to, displaying, playing back, or processing the instance of media content 105, or one or more components of the instance of media content 105 such as sound or video.

A client 125 may also include or be associated with one or more display devices allowing for the media content 105 to be experienced. Display devices may include, but are not limited to, display screens, televisions, computer monitors, handheld devices, speakers, or any other device or devices configured to allow for media content 105 presentation. The client 125 may further be configured to present additional information, such as an interactive program guide listing media content 105 that may be accessed by way of an IP channel or stream, a tuner of the home media server 115, and/or a listing of media content 105 stored on a storage device of the home media server 115 that are presently available.

The user may provide additional input commands to the home media server 115 as well. As some additional examples, the user may provide rewind or fast-forward commands to cause the client 125 to access different scenes or frames within media content 105 being received from a handler 120 of the home media server 115. The user may also provide a record input command configured to cause the client 125 to request a handler 120 of the home media server 115 to record the media content 105 instance currently being provided to the client 125. The user may also provide a pause command configured to cause the client 125 to pause a media content 105 instance. The user also may provide an interactive program guide command configured to evoke an interactive program guide. Additional input commands may be received by the client 125 from a user input device, such as left, right, up, down, and select commands configured to enable the user to evoke and/or navigate through various views and graphical user interfaces displayed by the client 125. For example, input commands may allow a user to request a handler 120 to cause an instance of media content 105 to be recorded to a storage device of the home media server 115.

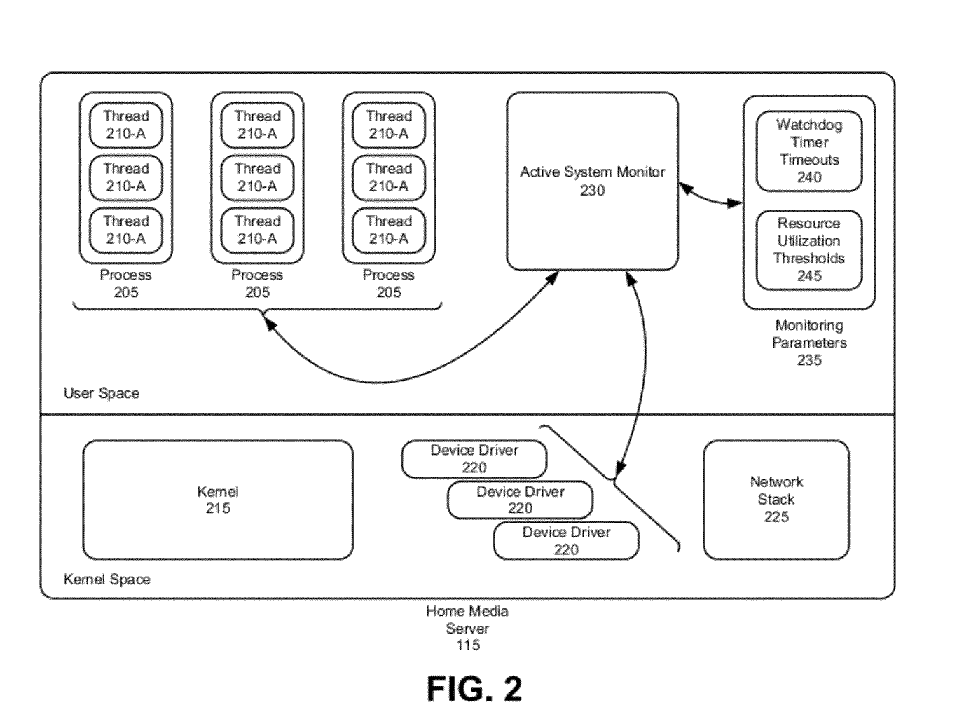

FIG. 2 illustrates an exemplary home media server 115 having an active system monitor or ASM 230. The home media server 115 may be configured to execute various entities, including one or more processes 205, each which may include one or more threads 210. The home media server 115 may further be configured to execute entities including a kernel 215, one or more device drivers 220, and a network stack 225 configured to support the function of the executed processes 205. Based on monitoring parameters 235, such as watchdog timer timeouts 240 and resource utilization thresholds 245, the active system monitor 230 may monitor the proper functioning of these entities executed by the home media server 115.

As compared to a computer program that may include an ordered collection of computer instructions, a process 205 is an instance of the execution of those computer instructions. One or more processes 205 may be executed by a computing device such as home media server 115. In addition to program instructions, the process 205 may further include state information regarding the activity of the process 205.

A thread 210 of execution may include a sequence of computer instructions to be executed, and a process 205 may include one or more threads 210. Threads 210 within a process may share memory, state information, and addresses space with other threads 210 of the same process 205, but not with threads 210 of other processes 205. Each thread 210 may be configured to execute program instructions concurrently or independently of other threads 210. As compared to processes 205, threads 210 may consume fewer computing resources but provide less isolation of execution. On the other hand, processes 205 may provide greater isolation as compared to threads 210, but at a greater cost of computing resources.

A kernel 215 is the core of a computer operating system, and serves to manage the resources of the home media server 115. The kernel 215 may provide basic services for use by processes 205 executed by the home media server 115, such as abstractions for processors, input/output, memory, and attached hardware devices. The kernel 215 may provide additional services for processes 205, such as scheduling of the execution of processes 205 and threads 210, inter-process communication between the processes 205, process 205 and thread 210 synchronization, process 205 and thread 210 context switching, handling of hardware devices, interrupt handling, and creation, suspension, resumption, and destruction of processes 205 and threads 210.

A device driver 220 may include executable code configured to allow the computing device to utilize a hardware device. A device driver 220 may be selectively loaded by the kernel 215 upon detection of the presence of a hardware device supported by the device driver 220. Device drivers 220 may expose a common interface to the kernel 215 and processes 205, and may internally implement the hardware-specific details of functionality performed by the attached hardware devices. The device drivers 220 may accordingly abstract away various details of the hardware implementation of the hardware device. Thus, device drivers 220 allow for the higher-level code of the processes 205 and threads 210 to be written to a standard interface, rather than to the specific hardware being employed by the particular home media server 115.

A network stack 225 may include an implementation of one or more networking protocols configured to facilitate communications over communications networks. For example, the network stack 225 may facilitate the communication of the home media server 115 with the media content provider 110 and the plurality of clients 125. An exemplary protocol that may be implemented by the network stack 225 is the open systems interconnection (OSI) layered model communication protocol. In the OSI model, a physical layer may function to provide for transmission of binary signals across on or more mediums; a data layer may provide physical addressing over the physical layer; a network layer may provide path determination and logical addressing over the data layer; a transport layer may provide connection, reliability, and flow-control functions over the network layer; a session layer may provide for communication between hosts over the transport layer; and a presentation layer may provide for representation of data, encryption, decryption, and conversion of data between machine-independent representations and machine-dependent representations over the session layer. An application layer may then use these lower layers to provide network facilities to the processes 205 and threads 210 to use.

The handlers 120 discussed above with respect to FIG. 1 may be implemented as processes 205 and/or threads 210 executed by the home media server 115. In some examples, the handlers 120 may be implemented as individual threads 210 executed within one or more processes 205. In other instances, each handler 120 of the home media server 115 may be implemented as its own separate process 205.

The handlers 120 may utilize the facilities provided to them by the kernel 215, device drivers 220, and network stack 225. For example, the handlers 120 may use the network stack 225 to facilitate networked communication with the clients 125. As another example, the handlers 120 may utilize services provided by the kernel 215 to perform processing, such as encoding and decoding of instances of media content 105 by way of one or more processors of the home media server 115.

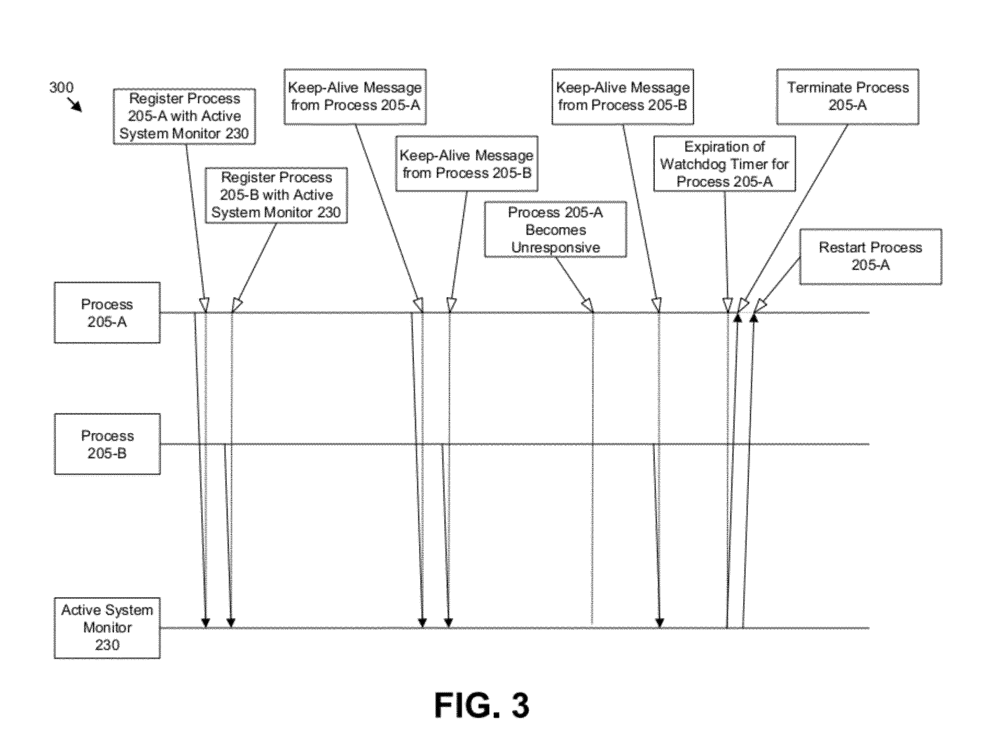

An active system monitor 230 may be included in the home media server 115. The active system monitor 230 may be configured to register entities such as processes 205, threads 210, handlers 120 and device drivers 220 to be monitored. The active system monitor 230 may further be configured to receive monitoring parameters 235 such as resource utilization watchdog timer timeouts 240 and thresholds 245 to configure the monitoring. The active system monitor 230 may be configured to detect issues with the registered entities based on the monitoring parameters 235, such as a handler 120 becoming unresponsive, a handler 120 or device driver 220 exceeding its allowed resource allocation, and a handler 120 exiting or crashing unexpectedly. The active system monitor 230 may be configured to remedy these issues to prevent performance degradation or loss of service, such as by terminating and/or restarting a handler 120 or by restarting the home media server 115. Exemplary scenarios regarding the use of the active system monitor 230 are described in detail with respect to FIGS. 3-5.

Monitoring parameters 235 may be specified to the active system monitor 230 in various ways. For example, the home media server 115 may receive monitoring parameters 235 from the media content provider 110. As another example, the home media server 115 may allow a user to configure monitoring parameters 235, such as through use of one of the clients 125. As yet another example, handlers 120 or device drivers 220 may specify their own monitoring parameters 235 upon registration with the active system monitor 230.

The monitoring parameters 235 may include watchdog timer timeouts 240. A watchdog timer timeout 240 may specify an amount of time for the active system monitor 230 to wait to receive a keep-alive message from a handler 120. These watchdog timer timeouts 240 may be used by the active server monitor 230 to detect issues with the registered entities becoming unresponsive. The active server monitor 230 may require registered entities to send keep-alive messages, and if an entity fails to do so, that entity may be considered unresponsive by the active server monitor 230 and terminated. More specifically, receipt of a keep-alive message from an entity by the active system monitor 230 within the watchdog timer timeout 240 period may indicate to the active system monitor 230 that the entity is responsive, while lack of receipt of the keep-alive message within the watchdog timer timeout 240 period may indicate that the entity is not responsive. If the keep-alive message is received within the watchdog timer timeout 240 period, the watchdog timer may then be reset to the watchdog timer timeout 240 value to wait for the next keep-alive message.

Watchdog timer timeouts 240 may be specified as unit of time given by an entity when being registered with the active system monitor 230, or may be read from a system default watchdog timer timeout 240 setting of the system. Watchdog timer timeouts 240 may further include a number of keep-alive messages that may be missed before an entity is determined to be unresponsive.

The monitoring parameters 235 may also include resource utilization thresholds 245. A resource utilization threshold 245 may specify a maximum amount of a system resource that may be utilized by an entity, such as a handler 120 or device driver 220, before requiring action by the active system monitor 230. Exemplary resource utilization thresholds 245 may include a maximum processor time threshold indicating a maximum amount of processor time to allow a handler 120 to consume before requiring action by the active system monitor 230, a maximum processor utilization threshold to allow a handler 120 to consume before requiring action by the active system monitor 230, and/or a maximum network bandwidth threshold to allow a handler 120 to consume before requiring action by the active system monitor 230.

As some examples, resource utilization thresholds 245 may be specified by a numeric amount of processor time, network bandwidth, memory consumed, file resources consumed, or storage resources consumed, or as a percentage of the total available processor time, network bandwidth, memory consumed, file resources consumed, or storage resources consumed. Resource utilization thresholds 245 may further include overall system resource utilization thresholds in addition to thresholds that are per-hander 120. For example, a resource utilization threshold 245 may specify an overall maximum amount to network bandwidth or processor time to allow for all handlers 120. In some examples, reaching an overall maximum resource utilization threshold 245 may indicate to the active server monitor 230 that the home media server 115 requires a restart.

As shown in FIG. 2, the active system monitor 230 is implemented within user space. However, in other examples, the active system monitor 230 may be implemented at least in part within the kernel space.

FIG. 3 illustrates an exemplary scenario 300 of the monitoring of entities for responsiveness by an active server monitor 230. As shown in the scenario 300, monitoring of the processes 205-A and 205-B may be performed by an active system monitor 230 included in a home media server 115, such as the active system monitor 230 described above with respect to FIGS. 1 and 2.

To allow for the active system monitor 230 to monitor the processes 205-A and 205-B, processes 205-A and 205-B may be registered with the active system monitor 230. As shown, first the processes 205-A is registered with the active system monitor 230, and then the process 205-B is registered with the active system monitor 230. In some examples, processes 205 may be registered automatically as a part of process 205 creation services included in the kernel 215. In other examples, processes 205 may be registered with the active system monitor 230 programmatically, such as by an initialization routine of a new client handler 120.

Monitoring parameters 235 may also be registered with the processes 205-A and 205-B as well. In some examples, monitoring parameters 235 may be specified by the processes 205- A and 205-B as part of registration. In other examples, the active system monitor 230 may utilize system default monitoring parameters 235.

Once registered, the active system monitor 230 may wait to receive keep-alive messages from the processes 205-A and 205-B. Receipt of a keep-alive message within the watchdog timer timeout 240 period informs the active system monitor 230 that the processes 205-A and 205-B are responsive. Upon receipt of a keep alive message from a process 205, the active system monitor 230 resets the corresponding watchdog timer timeout 240 period for that process 205. As shown, the active system monitor 230 receives a keep-alive message from the process 205-A which resets the watchdog timer for the process 205-A. The active system monitor 230 then receives a keep-alive message from the process 205-B, which resets the watchdog timer for the process 205-B.

In the exemplary scenario 300, at a point in time after receipt of the keep-alive message from the process 205-A, the process 205-A becomes unresponsive. For example, the process 205-A may suffer from a programming error or mistake, such as a deadlock caused by improper use of a synchronization object. In such a state, the process 205-A may no longer be able to respond to requests from clients 125 of the home media server 115. Any clients 125 mapped to or otherwise depending on the process 205-A may accordingly be experiencing decreased service or a total failure. Moreover, the unresponsive process 205-A may also potentially affect or otherwise disrupt service for other clients 125 of the home media server 115. In such a state, because the process 205-A is unresponsive, the process 205-A will also be unable to generate keep-alive messages to indicate to the active system monitor 230 that the process 205-A is responsive.

As shown in the scenario 300, the active system monitor 230 continues to receive keep-alive messages from process 205-B. However, the active system monitor 230 watchdog timer for process 205-A expires without receipt of a keep-alive message from process 205-A. Accordingly, because no keep-alive message was received, the active system monitor 230 determines that the process 205-A is no longer responsive.

Upon making the determination that the process 205-A is no longer responsive, the active system monitor 230 may terminate the process 205-A. The active system monitor 230 may then restart process 205-A and map any clients 125 that were depending on the unresponsive process 205-A to the restarted process 205, thus allowing those clients 125 to return to proper operation.

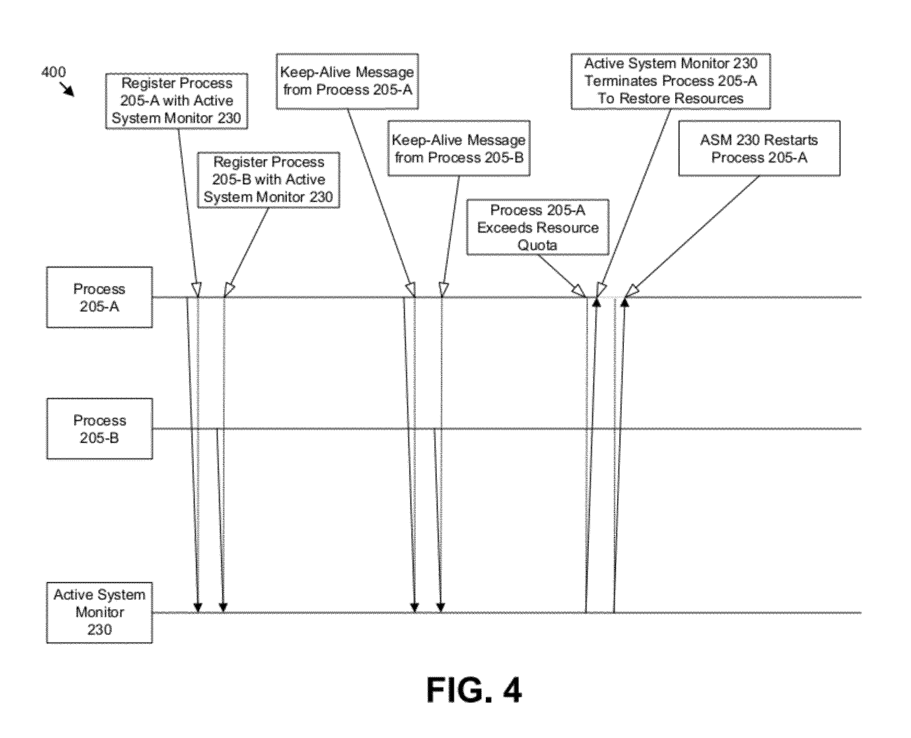

FIG. 4 illustrates an exemplary scenario 400 of monitoring of entities for resource utilization by an active server monitor 230. Instead of or in addition to the monitoring of processes 205 for responsiveness described in scenario 300, in scenario 400 the active system monitor 230 may monitor the processes 205-A and 205-B to ensure that they utilize resources within specified limits.

Similar to as described above, to allow for the active system monitor 230 to monitor the processes 205-A and 205-B, processes 205-A and 205-B may be registered with the active system monitor 230. Also similar to as described above, monitoring parameters 235 may be registered with the processes 205-A and 205-B as well.

These monitoring parameters 235 for process 205-A may include a resource utilization threshold 245 specifying a maximum amount of a system resource that may be utilized by the process 205-A before requiring action by the active system monitor 230. The monitoring parameters 235 for process 205-B may also include a resource utilization threshold 245.

Similar to as described above, the active system monitor 230 may waits to receive keep-alive messages from the registered processes 205-A and 205-B, and may resets the watchdog timer for the processes 205-A and 205-B upon receipt of keep-alive messages within the watchdog timer timeout 240 period for that process 240.

The active system monitor 230 may also monitor the resource utilization of the processes 205-A and 205-B. The active system monitor 230 may perform the monitoring by use of application programming interfaces capable of receiving information regarding resource usage. Merely as some examples of entity resources that may be monitored, the active system monitor 230 may monitor one or more of: mapped file size for a process, total virtual memory size of the process, resident set size for a process, non-swapped physical memory size used by process, amount of time that a process 205 or thread 210 has executed in kernel 215 mode, amount of time that a process 205 or thread 210 has executed in user mode, and amount of incoming or outgoing bandwidth utilized by a process 205 or thread 210.

At a certain point in time process 205-A begins to exceed a resource utilization threshold 245 associated with the process 205-A. Upon indication of this excessive resource usage, the active system monitor 230 terminates process 205-A. This accordingly allows the home media server 115 to reclaim the resources formerly being taken up by process 205-A. Termination of process 205-A may cause decreased service or a total failure of service for a client 125 mapped to or associated with the process 205-A. However, an interruption of service to one client 125 may be beneficial over a degradation or failure of service to the other clients 125 caused by the excessive resource usage of the process 205-A. Any clients 125 mapped to the terminated process 205-A may be mapped to another existing process 205 or to a new process 205-A to allow those clients 125 to regain service.

While scenario 400 illustrates an active system monitor 230 performing monitoring of processes 205, the active system monitor 230 may monitor other types of entities as well. As an example, the active system monitor 230 may perform monitoring of one or more device drivers 220 included in the home media server 115. This monitoring of device drivers 220 may be performed instead of or in addition to the aforementioned monitoring of processes 205. If a device driver 220 is found to be consuming resources in excess of a resource utilization threshold 245 associated with the device driver 220, then the offending device driver 220 may be terminated and restarted.

In many cases, the active system monitor 230 will be able to terminate the offending process 205, thread 210 or device driver 220. However, in some instances active system monitor 230 may not be able to terminate and restart a device driver 220 or other entity in use by the home media server 115. If the process 205, thread 210 or device driver 220 cannot be terminated (or cannot be terminated cleanly leaving the home media server 115 in a known state), then home media server 115 may be not able to continue normal operation after terminating the entity. Moreover, in some instances process 205, thread 210 or device driver 220 may have used up so many resources of the home media server 115 that the home media server 115 may no longer have adequate resources to terminate the entity, or to continue on even after terminating the entity. In such examples, to regain resources and/or functionality, the active system monitor 230 may instead be required to restart the entire home media server 115.

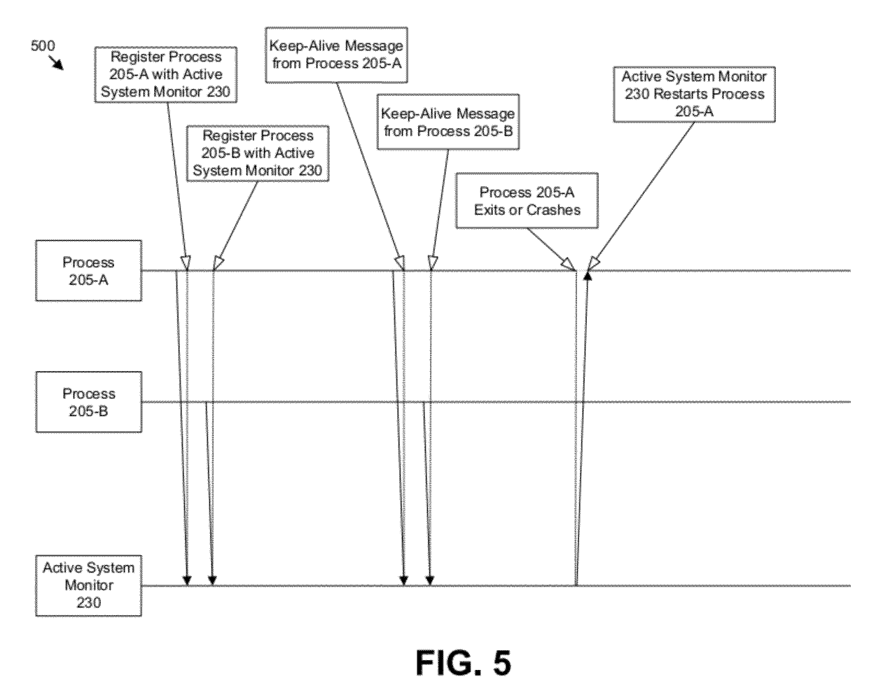

FIG. 5 illustrates an exemplary scenario 500 of monitoring entities for abnormal termination by an active server monitor 230. Instead of or in addition to the monitoring of processes 205 for responsiveness and resource utilization described above, the active system monitor 230 may further monitor the processes 205-A and 205-B to ensure that they remain alive.

Similar to as discussed above, to allow for the active system monitor 230 to monitor the processes 205-A and 205-B, processes 205-A and 205-B may be registered with the active system monitor 230. Also similar to as discussed above, monitoring parameters 235 may be registered with the processes 205-A and 205-B as well. As shown in scenario 500, processes 205-A and 205-B are registered with the active system monitor 230. Processes 205-A and 205-B further send keep-alive messages to the system monitor 230.

Moreover, the active system monitor 230 may monitor the processes 205-A and 205-B to ensure that they remain alive and running As some examples, the active system monitor 230 may monitor a process 205 for life by one or more of the following: monitoring the existence of a lock file created by the process 205, monitoring for a POSIX signal indicating that the process 205 has terminated, monitoring a global synchronization object held by the process 205 as being held by the process 205, and monitoring a handle to the process 205 for process 205 exit.

As shown in FIG. 5, process 205-A exits unexpectedly. Accordingly, the active system monitor 230 detects the exit of process 205-A, and restarts the process 205-A. The active system monitor 230 may further map or otherwise associate any clients 125 formerly associated with the old process 205-A to be mapped or associated with the new process 205-A. This may allow the clients 125 associated with the old process 205-A to recover functionality and/or continue to function, despite failure of the old process 205-A.

In sum, through use of the active system monitor 230, unresponsive entities may be detected and remedied, abnormal resource consumption may be detected and avoided, and resource limits of entities may be honored. In the event that an entity fails or behaves abnormally, that entity may be terminated and restarted, thereby mitigating the entity failure to only a single client 125 (or subset of clients 125) failure with recovery. Accordingly, the active system monitor 230 may provide failure mitigation and recovery to a home media server 115 that handles multiple client 125 devices in a home, addressing issues with the home media server 115 being a potential single point of failure for the system 100.

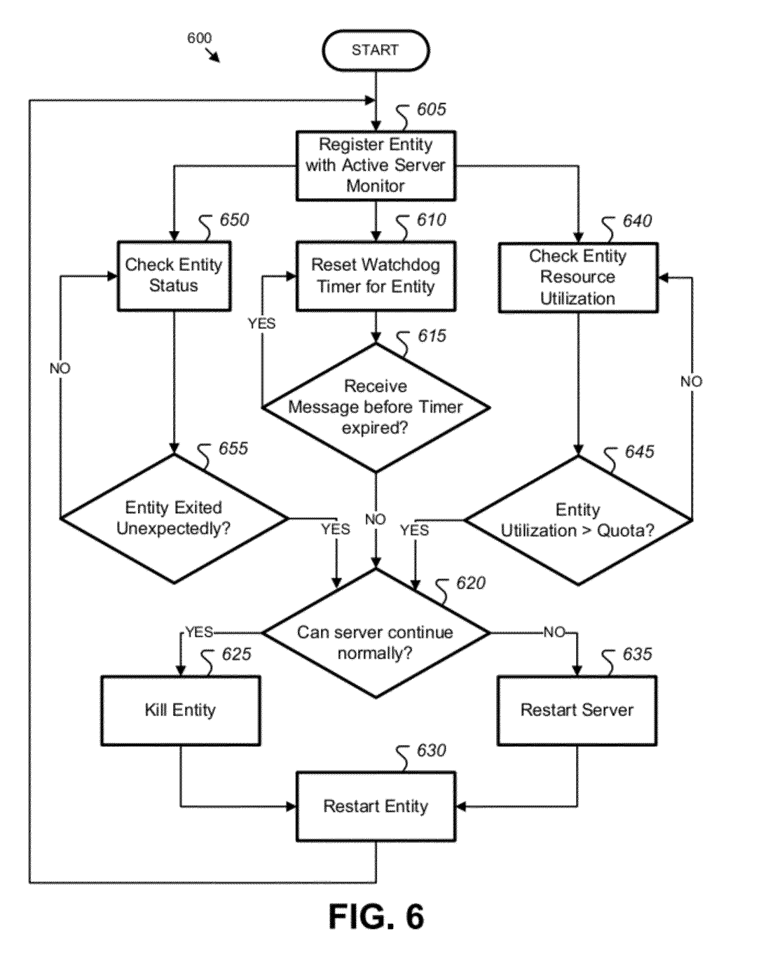

FIG. 6 illustrates an exemplary process 600 flow for monitoring of entities by an active server monitor 230. The process 600 may be performed by various systems, such as the system 100 described above. For example, the process 600 may be performed at least in part by the active system monitor 230 implemented as a part of the home media server 115.

In block 605, the active system monitor 230 registers an entity for monitoring. The entity may be a process 205 or thread 210 implementing one or more client handlers 120, or may be a device driver 220. The active system monitor 230 may further receive monitoring parameters 235 such as watchdog timer timeouts 240 and resource utilization thresholds 245 to configure the monitoring of the entity.

In block 610, the active system monitor 230 resets a watchdog timer for the entity. The watchdog timer may be set to time out based on a watchdog timer timeout 240 monitoring parameter 235 associated with the entity.

In block 615, the active system monitor 230 determines whether a keep-alive message is received from the entity before the watchdog timer timeout 240. If a keep-alive message is received by the active system monitor 230 before the watchdog timer expires, control passes to block 610. If the watchdog timer has not expired, the active system monitor 230 continues to wait for a keep-alive message from the entity. If the watchdog timer expires before the active system monitor 230 receives the keep-alive message, then control may pass to block 620. In some instances, the monitoring parameters 235 may require multiple keep-alive messages to be missed before passing control to block 620.

In block 620, the active system monitor 230 determines whether the home media server 115 can continue normally after terminating the entity. In many cases the active system monitor 230 will be able to terminate the entity. However, if the entity is a device driver 220 that cannot be unloaded, then then home media server 115 may be not able to continue normally after terminating the entity. Or the entity may have used up so many resources that the home media server 115 may no longer have adequate resources to terminate the entity. If the active system monitor 230 can terminate the entity, control passes to block 625. Otherwise control passes to block 635.

In block 625, the active system monitor 230 terminates the entity. This may accordingly free up any resources that were being expended by the entity.

In block 630, the active system monitor 230 restarts the entity. The active system monitor 230 may map or otherwise associate any clients 125 that were formerly mapped or associated to the terminated entity to be associated with the restated entity. After block 630, control may again pass to block 605.

In block 635, the active system monitor 230 restarts the home media server 115. Restarting the home media server 115 may cause a temporary interruption of service to one or more of the clients 125 of the home media server 115. However, restarting the home media server 115 may allow the home media server 115 to return to a fully operational state, and avoid becoming inoperative to the point where user intervention may be required. After block 635, control may pass to block 630.

In block 640, the active system monitor 230 checks the resource utilization of the entity. For example, the active system monitor 230 may perform the monitoring by use of application programming interfaces capable of receiving information regarding resource usage. As some examples of resources that may be monitored, the active system monitor 230 may monitor one or more of: mapped file size, total virtual memory size, resident set size, non-swapped physical memory size, amount of time for which an entity has executed in kernel 215 mode, amount of time that an entity has executed in user mode, and amount of incoming or outgoing bandwidth utilized by an entity.

In decision point 645, the active system monitor 230 determines whether the resource utilization of the entity exceeds a resource utilization threshold 245 associated with the entity. If the resource utilization exceeds the resource utilization threshold 245, control passes to block 620. Otherwise control passes to block 640.

In block 650, the active system monitor 230 checks the status of the entity. As some examples, the active system monitor 230 may monitor an entity by one or more of the following: monitoring the existence of a lock file created by the entity, monitoring for a POSIX signal indicating that the entity has terminated, monitoring a global synchronization object held by the entity as being held by the entity, and monitoring a handle to the entity for the entity to exit.

In decision point 655, the active system monitor 230 determines whether the entity existed unexpectedly. For example, the active system monitor 230 may have explicitly terminated the entity, or the entity may have been scheduled to have quit. On the other hand, the entity may have terminated in an unanticipated manner. If the entity terminated unexpectedly, control may pass to block 620.

It should be noted that process 600 is merely one exemplary method that may be performed by the active system monitor 230, and that variations may be possible. For example, one or more of blocks 610, 640, and 650 may be executed substantially simultaneously, such as by multiple threads 210 of the active system monitor 230. As another example, restarting the home media server 115 in block 635 may also restart the entities, and control may pass directly to block 605.

In general, computing systems and/or devices, such as media content provider 110, home media server 115 and client 125, may employ any of a number of computer operating systems, including, but by no means limited to, versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Examples of computing devices include, without limitation, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

### Conclusion

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope of the application should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the disclosed systems and methods are capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising:
a home media server;
a plurality of clients of the home media server;
a plurality of entities executed by the home media server and configured to provide media content instances to the plurality of clients; and
an active server system monitor configured to:
register an entity of the plurality of entities,
determine at least one monitoring parameter associated with the registered entity,
monitor the registered entity according to the at least one monitoring parameter to determine an issue with the registered entity, and
if an issue is determined, terminate and restart the registered entity.

2. The system of claim 1, further comprising a media content provider configured to provide instances of media content to the home media server.

3. The system of claim 1, wherein the registered entity is a client handler associated with one of the plurality of clients of the home media server.

4. The system of claim 3, wherein the client handler is configured to receive requests for media content from the associated client and provide requested media content to the associated client.

5. The system of claim 3, wherein the at least one monitoring parameter include a watchdog timer timeout, and wherein the active server system monitor is further configured to:
set a watchdog timer based on the watchdog timer timeout;
monitor for receipt of a keep-alive message from the client handler;
determine whether the client handler is unresponsive based on whether a keep-alive message is received from the client handler before the watchdog timer timeout; and
if the client handler is unresponsive, flag the client handler as having an issue.

6. The system of claim 5, wherein the active server system monitor is further configured to associate another of the plurality of entities with the one of the plurality of clients when the client handler is determined to be unresponsive.

7. The system of claim 5, wherein the active server system monitor is further configured to associate the restarted entity with the one of the plurality of clients when the client handlers determined to is unresponsive.

8. The system of claim 1, wherein the entity is a device driver of the home media server.

9. The system of claim 1, wherein the active server system monitor is further configured to:
register a second entity;
determine at least one monitoring parameter associated with the second registered entity;
monitor the second registered entity according to the at least one monitoring parameter associated with the second registered entity to determine an issue with the second registered entity; and
if an issue is determined, terminate and restart the second registered entity.

10. A method, comprising:
registering an entity with an active server system monitor configured to monitor a home media server;
determining at least one monitoring parameter associated with the registered entity;
monitoring the registered entity according to the at least one monitoring parameter to determine an issue with the registered entity; and
if an issue is determined, terminating and restarting the registered entity.

11. The method of claim 10, wherein the entity is a client handler receiving requests for media content from a client and providing requested media content to the client.

12. The method of claim 10, wherein the at least one monitoring parameter includes a watchdog timer timeout, and further comprising:
setting a watchdog timer based on the watchdog timer timeout;
monitoring for receipt of a keep-alive message from the registered entity;
determining whether the registered entity is unresponsive based on whether a keep-alive message is received from the registered entity before the watchdog timer timeout; and
if the registered entity is unresponsive, flagging the registered entity as having an issue.

13. The method of claim 10, wherein the at least one monitoring parameter includes a resource utilization quota, and further comprising:
checking a utilization of a resource of the registered entity;
comparing the utilization of a resource of the registered entity to the resource utilization quota;
determining whether the registered entity is utilizing excessive resources based on the comparison; and
if the registered entity is utilizing excessive resources, flagging the registered entity as having an issue.

14. The method of claim 10, further comprising:
checking the status of the registered entity;
determining whether the registered entity exited unexpectedly; and
if the registered entity has exited unexpectedly, restarting the registered entity.

15. The method of claim 10, wherein the registered entity is one of a process, a thread, or a device driver.

16. The method of claim 10, further comprising:
determining that the home media server cannot continue normally based on the determined issue; and
restarting the home media server.

17. A computer-readable medium tangibly embodying computer-executable instructions that when executed by a processor are configured to cause the computing device to:
register a client handler with an active system monitor, the client handler being configured to receive requests for media content from a client and provide requested media content to the client;
determine at least one monitoring parameter associated with the client handler;
monitor the client handler according to the at least one monitoring parameter associated with the client handler to determine an issue with the client handler, and
if an issue is determined, terminate and restart the client handler.

18. The computer-readable medium of claim 17, further comprising instructions configured to:
check utilization of a resource of the client handler;
compare utilization of the resource of the client handler to a resource utilization quota included in the at least one monitoring parameter associated with the client handler;
determine whether the client handler is utilizing excessive resources based on the comparison; and
if the client handler is utilizing excessive resources, flagging the client handler as having an issue.

19. The computer-readable medium of claim 17, further comprising instructions configured to associate the restarted client handler with the client.

20. The computer-readable medium of claim 17, further comprising instructions configured to:
set a watchdog timer based on a watchdog timer timeout included in the at least one monitoring parameter associated with the client handler;
monitor for receipt of a keep-alive message from the client handler;
determine whether the entity is unresponsive based on whether a keep-alive message is receive from the client handler before the watchdog timer timeout; and
if the client handler is unresponsive, flag the client handler as having an issue.

21. The computer-readable medium of claim 17, further comprising instructions configured to:
check the status of the client handler;
determine whether the client handler exited unexpectedly; and
if the client handler has exited unexpectedly, restart the client handler.

22. The computer-readable medium of claim 17, further comprising instructions configured to receive and process instances of media content received from a media content provider.
